(19) United States
(12) Patent Application Publication
(10) Pub. No.: US 2015/0375657 A1
(43) Pub. Date: Dec. 31, 2015

(54) Special heating floor mat device and systems for heavy duty and commercial vehicle applications

(71) Applicants: Randy Braun, New Castle, IN (US); Michael Braun, New Castle, IN (US)

(72) Inventors: Randy Braun, New Castle, IN (US); Michael Braun, New Castle, IN (US)

(21) Appl. No.: 14/847,034

(22) Filed: Sep. 8, 2015

Related U.S. Application Data
(63) Continuation-in-part of application No. 13/206,801, filed on Aug. 10, 2011, now abandoned.

(51) Int. Cl. B60N 3/04; H05B 3/06; H05B 1/02; H05B 3/00; H05B 3/36

(52) U.S. Cl. CPC B60N 3/048; B60N 3/046; H05B 3/0014; H05B 3/36; H05B 1/0236; H05B 3/06

(57) ABSTRACT

A device made of an electrically heatable floor mat with a non-slip surface; at least one hold down component with features to enable the mat to be safely and removably secured to a floor board of a vehicle; and electrical conductors for the resistance heating in the mat, for connecting the mat to a power source on the commercial vehicle, and for enabling controlled heat to be delivered to the floor board whereby the device in turn helps to reduce icy and wet conditions in the compartment of the vehicle. An alternative embodiment includes a boost transformer/converter to produce higher voltage and enable the heating conductors to be smaller and easier for manufacturing the heating mat.

### CROSS-REFERENCE TO RELATED APPLICATIONS

This application is a Continuation-in-Part [C.I.P.] filed under 37 CFR 1.53(b) and claims the benefit of the original, non-provisional (Regular Utility) U.S. patent application Ser. No. 13/206,801 submitted Aug. 10, 2011 and Published Apr. 19, 2012 as US 2012-0091109-A1. The original application was still active on the date of the submission of this C.I.P. The original application and publication are entitled a “Special heating floor mat device for heavy duty applications” and was submitted by Randy Braun, et al. The original application is incorporated fully by reference as if it were reproduced here, verbatim. This application also claims the benefit of Provisional Patent Application Ser. No. 61/393,879 filed Oct. 16, 2010 by Randy Braun et al and entitled “Special heating floor mat device for heavy duty applications”.

### FIELD OF INVENTION

This invention relates to a Special heating floor mat device and systems for heavy duty and commercial vehicle applications. Particularly this heating product is related to heavy duty operations in large commercial vehicles where persons are exposed to long periods of cold and icy conditions. These persons need a way to warm their feet as well as remove the ice and water build-up inside their vehicles.

The Special heating floor mat device and systems for heavy duty and commercial vehicle applications works from electrical resistive heat which is originally powered by a 12 volt or greater electrical, on board power source. This means that heat comes from the on board electrical power of the vehicle's battery(ies) or an alternative source. The mat device is secured to the floorboard of the vehicle and has an anti-slip/gripping surface with traction. The power source is controlled various ways and the application may be installed with a fused connection. A voltage converter may be used to boost the voltage and thus decrease the size of the conductors required in the mat to maintain or increase the power/heat available. The applications anticipate original equipment or aftermarket installation for the device into various vehicles as discussed below.

FEDERALLY SPONSORED RESEARCH: None.

### SEQUENCE LISTING OR PROGRAM

None.

### BACKGROUND-FIELD OF INVENTION AND PRIOR ART

A. Introduction of the Problems Addressed

Winter ice and snow can be a nuisance and can present dangerous and extreme conditions. Drivers and passengers of large vehicles such as semi-tractors, snow plows, transportation and cargo trucks and busses and other similar vehicles may often be exposed to long periods of cold and icy conditions. These persons need a way to warm their feet as well as a manner to remove the ice and water build-up inside their vehicles. This heating product by Braun addresses and solves this problem. These persons in the wintery conditions need a way within the power constraint of the vehicle to improve or eliminate the snow and ice. There have there have been attempts to provide heat mats or other devices for vehicles in the past but these attempts did not address the problem as efficiently and cost effectively as will be seen. There has been in the trucking industry and with other commercial vehicles a long felt need to address the problem without a technological answer. Prior devices and methods will be described, but they failed to solve the problem. Persons who are familiar with heating means and with vehicle mats well appreciate the simplicity and cost effectiveness of this new device presented here by Braun. In the other prior art disclosures shown, complex and expensive alternatives are demonstrated. These are not only costly to manufacture but bulky, and difficult to use in the trucking and shipping industries.

B. Prior Art

In prior art, disclosures have been made, many including large and complex devices and systems to heat mats and interior compartments. A U.S. Pat. No. 2,544,547 issued in 1951 to Vogel shows an electrically heated floor mat that is an alternating current device without controls. It is a resistance device but nowhere describes or anticipates use with an automobile or mobile vehicle which is the target market and use for the Braun device. Braun specifically anticipates an on board, direct current power source utilized with large vehicle like trucks or busses.

Another device shows a utility device called a floor mat for an overland vehicle. It was issued in 1995 to Roberts as U.S. Pat. No. 5,439,725. It teaches a floor mat for an overland vehicle which includes a pair of polymeric based sheets which are joined together and which have individually unique filler contents, as well as predetermined thickness dimensions. The features of the first sheet includes a carpet having a predetermined surface texture which is fixed on the top surface of the uppermost based sheet wherein the uppermost sheet has an appearance which visually imitates the surface texture of the carpet such that the entire floor covering appears to be uniform. It also includes a floor mat having a sheet having a moderate fill content and which has portions of its upper facing surface painted thereby visually imitating a fabricated colored sheet. The system teaches a large universal mat that is then cut or sized for the specific vehicle. It anticipates savings through a universal one-size “can be cut” to fit all. The concept on its face anticipates much waste compare to the Braun, specifically fit device.

A utility device called a vehicle floor of a passenger car tries to integrate floor features into the original equipment manufacturing. Issued in 2001 to Felsen, U.S. Pat. No. 6,318,796 teaches the vehicle floor of a passenger car having a base plate, having a soundproofing floor covering applied to the base plate, an air-conditioning duct which extends in the floor covering, a duct outlet which opens into the vehicle rear, and carries conditioned air from an air-conditioning device of the vehicle into the vehicle rear. To reduce the introduction of sound into the vehicle rear through the air-conditioning duct, the invention provides for a sound and vibration de-coupler portion extending between the air-conditioning device and the duct outlet. The teaching compared to the Braun device is far more complex and addresses needs for sound and heat retention associate with air conditioned interiors. However, the use of a mat is taught, but the concept does not anticipate or lead one skilled in the art to associate the mat with heating coils which is basic with the Braun teaching.

A 2004 utility U.S. Pat. No. 6,834,159 issued to Schramm is a complex aircraft heated floor panel. The complexity drives the cost higher as compared to the simple, layered configuration shown and taught herein by Braun. The Schramm device teaches an aircraft floor panel comprising a plurality of layers cured together to form a lower support level and an upper heater level, and a metal face sheet for protecting the underlying layers from floor-traffic related damage. A pressure sensitive adhesive (or other adhesive which retains elasticity after bonding) is used to bond the metal face sheet to the underlying support/heater layers so that the different rates of thermal expansion can be accommodated during curing and cooling steps of the manufacturing process.

Another recent foot heating system is shown by Usselman et al. in a U.S. Pat. No. 6,897,417 issued in 2005. Here there is taught a device where each mat of a plurality of mats has an electrical resistance heater embedded therein between a layer of vinyl and a layer of cloth-like material. The mats are located in a motor vehicle and are connected to the on board power system of the motor vehicle via a cigarette lighter-type attachment and are controlled by a control element. Each mat has a crown and a gutter so water generated by melting snow or ice is controlled and prevented from running off the mat. The Usselman device shares the power to 4 devices and thus reduces the effectiveness, especially with ice build-up, of concentrated power to only one or two wheel wells like Braun describes.

A recent device for a heated mat apparatus was described in a U. S. Patent Application US 2007/0131666 by Gregg et al. Here the present disclosure relates to a heated mat having a heater carried by a mat construction. The mat construction includes a mat layer with drainage openings positioned at a non-peripheral region of the mat layer to allow melted ice to flow through from the top side to the bottom side of the mat layer. A drainage space is positioned beneath the mat to allow water to flow underneath and away from the mat construction. The mat is described for use with electrical power outlet and not a vehicle 12 volt system as described by Braun. Gregg is an alternating current (A/C) device useful to melt ice for roofs and gutters. The heating element it cites is an A/C device.

A patent Publication US 20090139973 for Hung was entitled “VEHICLE FLOOR HEATING DEVICE”. It taught multiple layers, multiple mats and cavities interspaced to provide a warming air or fluid. Hung fails to describe the amps of the system and is incorporated with the HVAC system and its air flow (par 33, 34, 35 and duct 64). It teaches some sort of electrical foil or layer 28 in par. 28 . . . not specific conductors like Braun. A U.S. Pat. No. 2,810,672 issued to Taylor in 1957 is entitled “FLOOR MATS FOR AUTOMOBILES”. Taylor is simply a basic floor mat. No heating is taught or suggested as in the Braun ideas.

A U.S. Pat. No. 7,820,950 was issued to Keite in 2010 entitled “INTRINSICALLY HEATABLE PRESSURE-SENSITIVE ADHESIVE PLANAR STRUCTURES”. This specification by Keite describes a compounded mat filler with electrically conducive filler. This is grossly unlike Braun's mechanical combination of the support mat and wires and the top, non-slip heatable mat. A U.S. Pat. No. 8,143,554 was issued to Lofy in 2012 and entitled “Air Warmer”. Lofy is strictly an air warmer without similarities to the others. Therefore the fusible link shown does not matter as this is not analogous art.

A patent application US 2009/0206067 by Foss was entitled “Composite Material, Heating Products and Method for Making”. The Foss abstract simply summarizes Foss: Uniform heating with low voltage electrical power supply is provided by sheet form products as free standing films, coatings, or embedded in laminates, foams and the like and comprising a carbon black/graphite composite dispersed in a plastic carrier. Foss teaches a composite material for low voltage het conduction. The mat in Braun teaches as amended to show the composite mat as heatable from the conductor elements. Foss is heatable as it conducts electricity through the graphite and the actual film—not conductors. A U.S. Pat. No. 7,071,447 was issued to Vu in 2006 and was entitled “An Automobile Coffee Maker”. Vu is a coffee maker for a vehicle. It is non-analogous to the mats described for Usselman, Hung and Braun. It has no relationship to Taylor and certainly not the A/C roof/gutter deicer of Gregg. No suggestion with Vu makes the large, 12 volt, 20 amp systems or larger as obvious to one skilled in the art of heated mats. Finally, a U.S. Pat. No. 6,239,409 was issued to Bonn in 2001 and was entitled “HEATING DEVICE FOR HEATING A MOVEABLE PART OF AN AUTOMOBILE, ESPECIALLY A STEERING WHEEL HEATER” Bonn is a complex and complete design with many more component parts to approach this heating device and system as shown and taught by Braun.

None of the prior art devices show the simple and functional configuration as the new special heating floor mat device for heavy duty applications. As far as known, there are no special heating floor mat device for heavy duty applications or the like. They are not anticipated by prior art. It is believed that this product is unique in its design and technologies. It is believed that this device is made with fewer parts and with improved configurations and physical features to provide more functionality when compared to other currently utilized devices or methods to remove ice and snow from the floors of vehicles.

### SUMMARY OF THE INVENTION

This invention is a Special heating floor mat device and systems for heavy duty and commercial vehicle applications. Taught here are the ways a heavy duty resistive device may be placed safely and securely on a floor board of a heavy duty and commercial type vehicles. One or more of the Special heating floor mat devices is/are placed and removably secured on the floor board and then controllably connected to a 12 volt, high amperage (greater than 15 amps) electrical power source. An alternative embodiment includes a boost transformer/converter to produce higher voltage and enable the heating conductors to be smaller and easier for manufacturing the heating mat. This may be as an original equipment option or an add-on system sold in the equipment aftermarket.

The preferred embodiment of the Special heating floor mat device and systems for heavy duty and commercial vehicle applications is comprised of a special electric heatable floor mat with a non-slip surface; at least one hold down component with features to enable the mat to be removably secured to a floor board; electrical conductors internal to the mat for the resistance heating in the mat and for connecting the mat to an onboard power source of at least 12 volts and 20 amps wherein the mat may be placed on a floor of a vehicle and connected to a power source to enable controlled heat to be delivered to the floor board and to reduce icy and wet conditions in the compartment of the vehicle. The mat may be plastic, urethane, neoprene or other composite materials to enclose the conductors internal to the mat and transfer the electrically produced heat to the vehicle's compartment at the floor board area. An alternative embodiment also comprises the above and a means for controlling the power to the conductors from the power source. An alternative embodiment may include a boost transformer/converter to produce higher voltage and enable the heating conductors to be smaller and easier for manufacturing the heating mat.

The newly invented Special heating floor mat device for heavy duty applications may be manufactured at low volumes by very simple means and in high volume production by more complex and controlled systems.

### Objects and Advantages

There are several objects and advantages of the Special heating floor mat for heavy duty applications Device. There are currently no known heavy duty application heating mats that are effective at providing the objects of this invention.

In the transportation field if a heavy duty vehicle is exposed to very cold and icy weather conditions, the ice and water collects on the floor board and poses safety risks as well as undesirable ergonomical conditions of cold and wet conditions inside the vehicle compartment. This Special heating floor mat for heavy duty applications device improves the conditions and even melts the ice and keeps the floor board relatively dry. The anti-slip surface can improve the footing of the user of the vehicle.

The Special heating floor mat device and systems for heavy duty and commercial vehicle applications may increase the safety of the vehicle's compartment by eliminating or reducing the icy and wet conditions. When driving in inclement weather conditions, the use of the Special heating floor mat for heavy duty applications device:
permits the driver to keep his feet warmer and dryer;
reduces ice and moisture in the compartment; and
reduces the potential for slip and falls when entering and exiting the vehicle;
higher voltage allows for smaller resistance wires and easier manufacturing of the mats.
higher amperage 20 amps) provides greater power to the mats.

Finally, other advantages and additional features of the present Special heating floor mat for heavy duty applications device will be more apparent from the accompanying drawings and from the full description of the device. For one skilled in the art of heated mat devices for vehicles, it is readily understood that the features shown in the examples with this product are readily adapted to other types of heated mat systems and devices.

### DESCRIPTION OF THE DRAWINGS

### Figures

The accompanying drawings, which are incorporated in and constitute a part of this specification, illustrate an embodiment of the Special heating floor mat device and systems for heavy duty and commercial vehicle applications that is preferred. The drawings together with the summary description given above and a detailed description given below serve to explain the principles of the Special heating floor mat device and systems for heavy duty and commercial vehicle applications. It is understood, however, that the Special heating floor mat device for heavy duty applications is not limited to only the precise arrangements and instrumentalities shown.

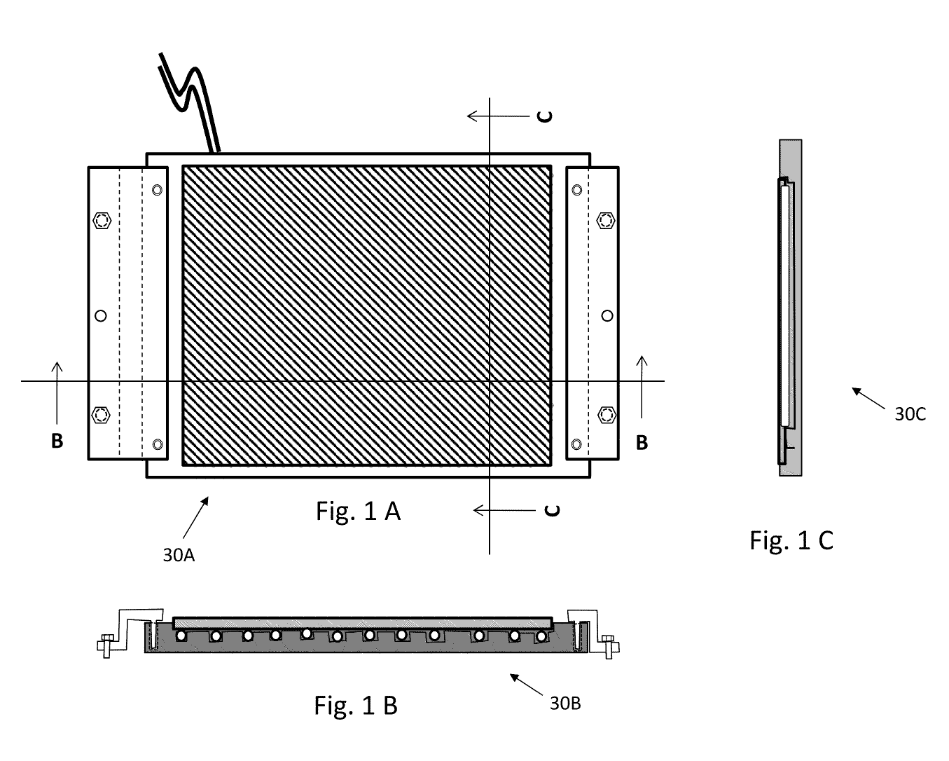

FIGS. 1 A through 1 C are sketches of the general Special heating floor mat for heavy duty applications device.

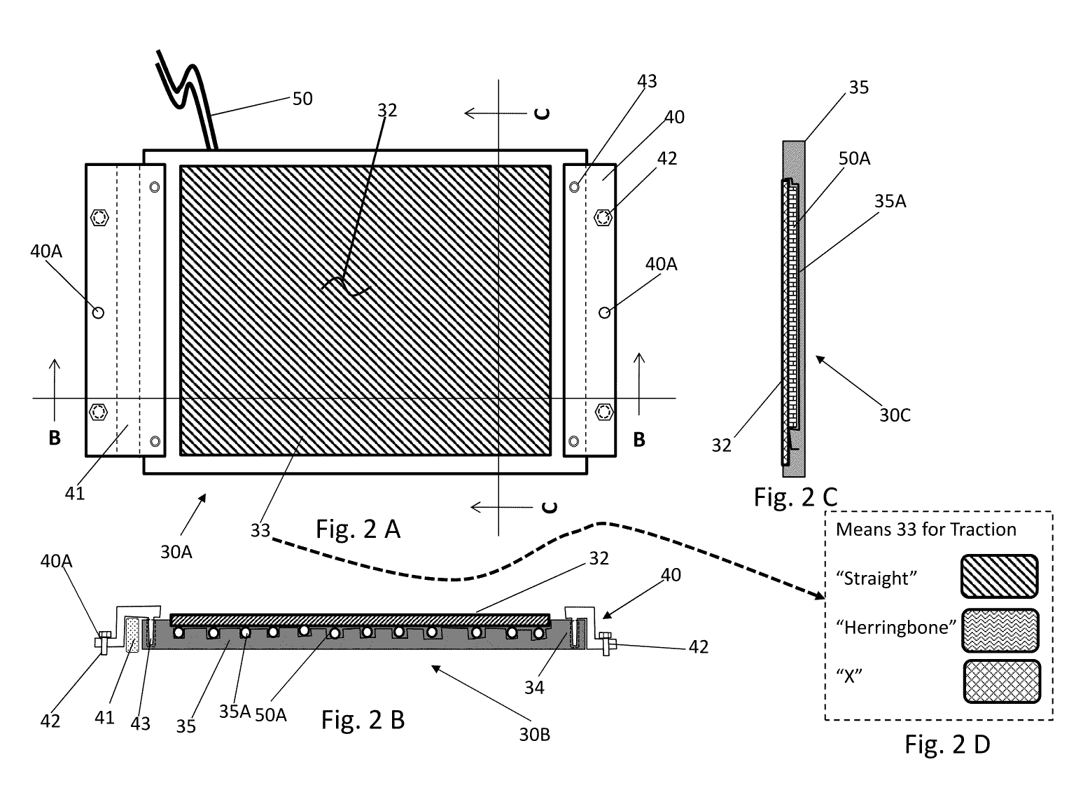

FIGS. 2 A through 2 C are sketches of the general Special heating floor mat for heavy duty applications device with components and features noted.

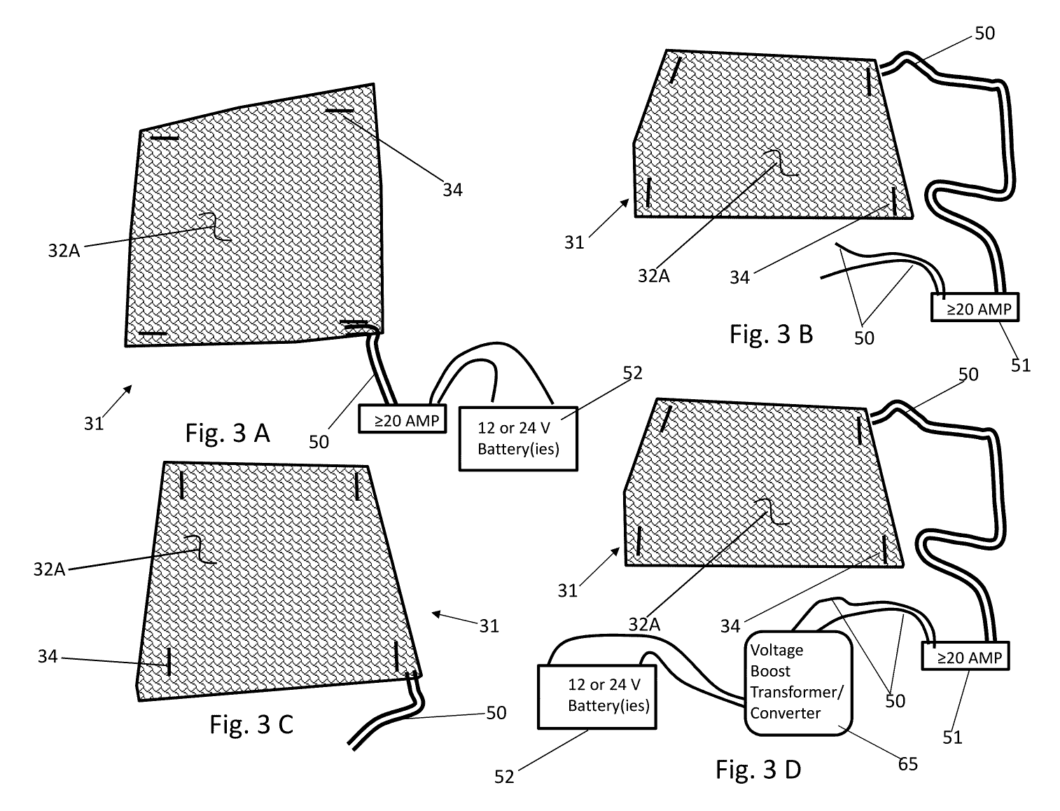

FIGS. 3 A through 3 D are sketches of a prototype sample with the components and features shown from generally a top view. The CIP includes a boost feature FIG. 3 D.

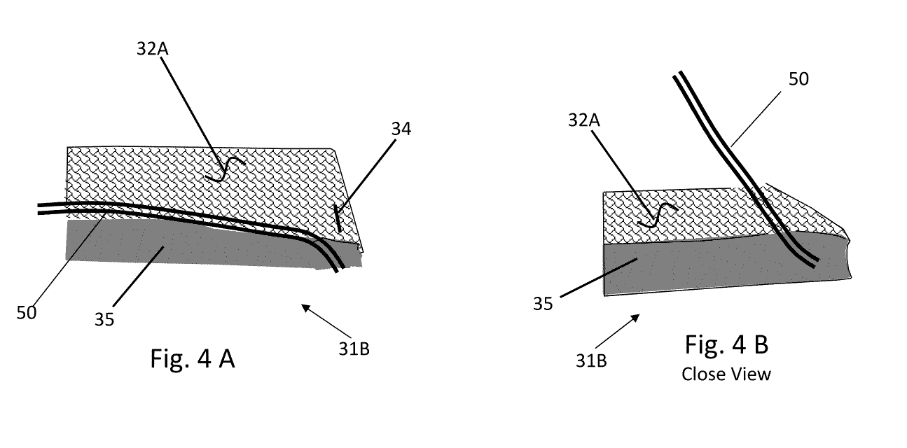

FIGS. 4 A and 4 B are sketches of a prototype sample with the components and features shown from generally a side section.

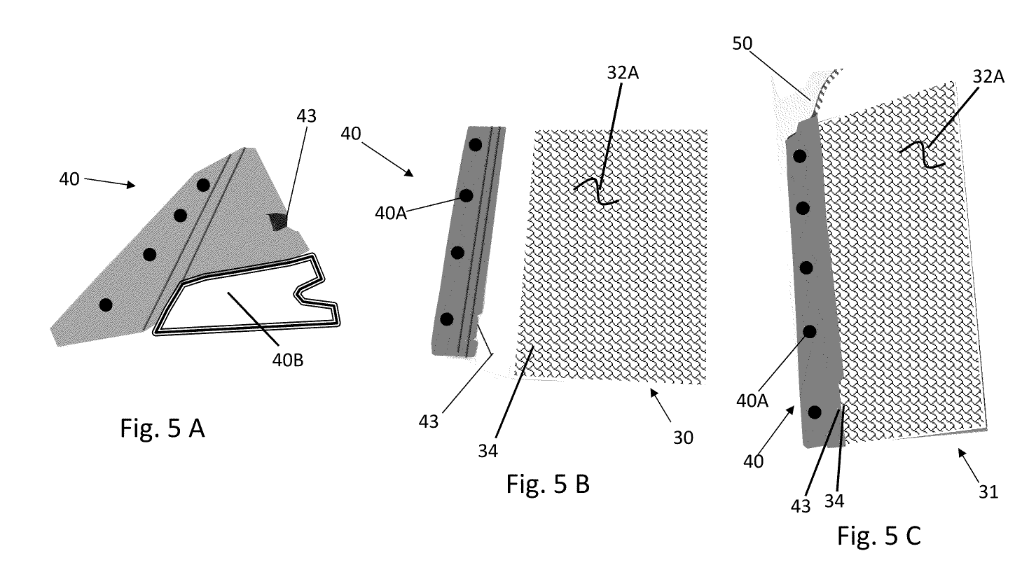

FIGS. 5 A through 5 C are sketches of a prototype sample with the components and features including the hold down component shown from generally a top view.

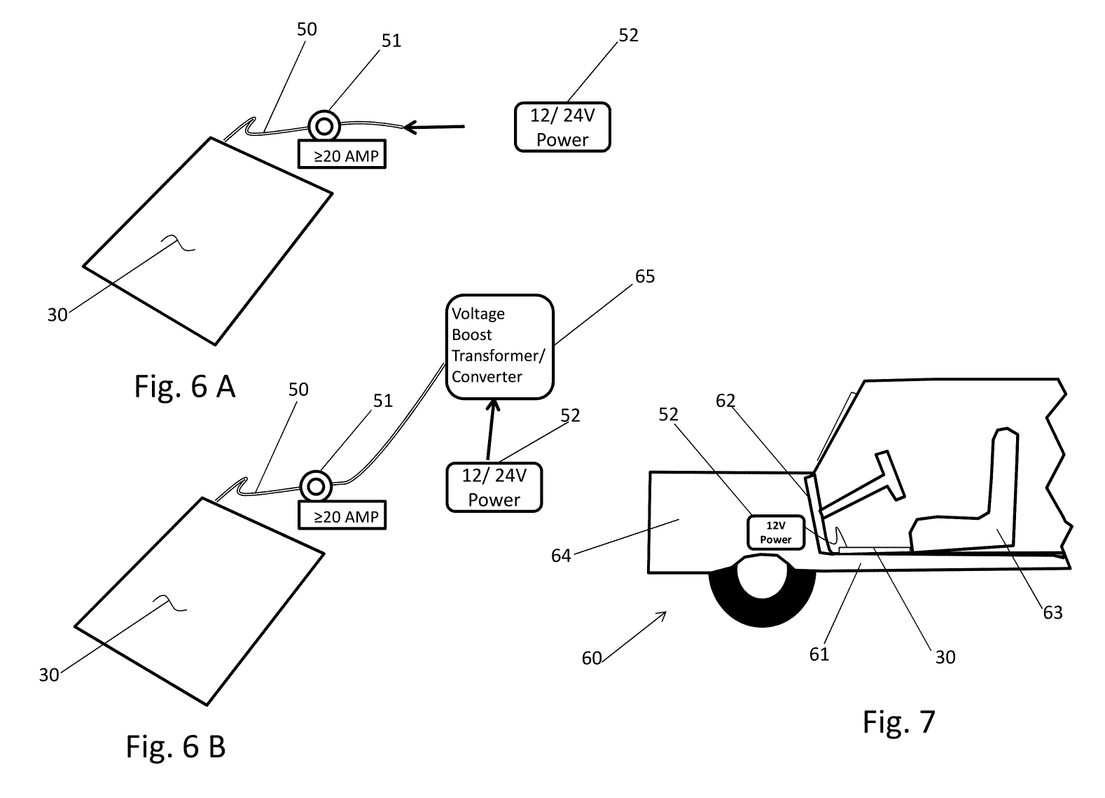

FIG. 6 is a sketch of the Special heating floor mat for heavy duty applications device in conjunction with the on board power source.

FIG. 7 is a sketch of the Special heating floor mat device and systems for heavy duty and commercial vehicle applications in conjunction with the vehicle and how the device is used.

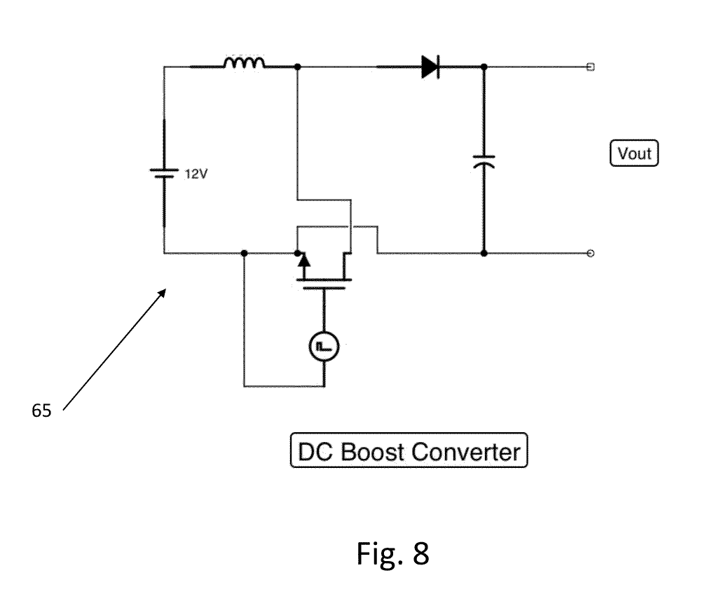

FIG. 8 is a sketch of the boost transformer/converter used with the Special heating floor mat device and systems for heavy duty and commercial vehicle applications as shown in this CIP.

### DESCRIPTION OF THE DRAWINGS

### Reference Numerals

The following numbers refer to the drawings:

| Ref # | Description |
|---|---|
| 30 | Special heating floor mat device for heavy duty applications |
| 30A | Top View of special device |
| 30B | Side section of special device |
| 30C | End section of special device |
| 31 | Prototype Special heating floor mat device for heavy duty |
| | applications |
| 31B | Side section of special device prototype/sample |
| 32 | Surface of mat |
| 32A | Prototype/sample mat surface |
| 33 | Means for traction on mat |
| 34 | Opening/aperture in mat for hold down extension clip |
| 35 | Support mat with a material means to contain resistance heat line |
| | such as closed cell urethane or equal |
| 35A | Recess/opening in 35 material for resistance wiring 50A |
| 40 | Hold down component |
| 40A | Opening/aperture in hold down component for securement |
| | means 42 |
| 40B | Opening/channel in hold down for resistance mat 32 |
| 41 | Opening or wire way in extended hold down component |
| 42 | Fastening means to secure hold down component 40 and/or 40A |
| | to floor board 61 of vehicle 60 |
| 43 | Hold down extension clip to secure mat 30 to hold down 40 |
| 50 | Power wiring at least two conductors - copper. aluminum, |
| | composite or the like |
| 50A | Resistance wiring |
| 51 | Fusible Power controller such as a switch, a rheostat and/or a fuse |
| | device - replaceable or resettable |
| 52 | Power supply (nominal 12 Volt or greater (if system designed for |
| | alternate power) on board |
| 60 | vehicle |
| 61 | Vehicle floor board |
| 62 | firewall |
| 63 | Vehicle seat |
| 64 | Engine compartment or where power supply resides |
| 65 | Voltage Boost Transformer/Converter - converts 12 and 24 V to |
| | higher voltages such as 18, 24, 36, and 48 volts 65 |

### DETAILED DESCRIPTION OF PREFERRED EMBODIMENT

The present development is a Special heating floor mat device and systems for heavy duty and commercial vehicle applications. Particularly this heating product is related to heavy duty operations in large vehicles where persons are exposed to long periods of cold and icy conditions. These persons need a way to warm their feet as well as remove the ice and water build-up inside their vehicles.

Taught here are the ways a heavy duty resistive device may be placed safely and securely on a floor board of a heavy duty vehicle. One or more of the Special heating floor mat devices is/are placed and removably secured on the floor board and then controllably connected to a 12 volt electrical, on board power source. This may be as an original equipment option or an add-on system sold in the equipment aftermarket.

The advantages for the Special heating floor mat device and systems for heavy duty and commercial vehicle applications 30 are listed above in the introduction. Succinctly the benefits are that the device:
permits the driver to keep his feet warmer and dryer;
reduces ice and moisture in the compartment;
reduces the potential for slip and falls when entering and exiting the vehicle;
higher voltage allows for smaller resistance wires and easier manufacturing of the mats; and
higher amperage (≧20 amps) provides greater power to the mats.

The preferred embodiment of the Special heating floor mat device and systems for heavy duty and commercial vehicle applications is comprised of a special electric heatable floor mat with a non-slip surface; at least one hold down component with features to enable the mat to be removably secured to a floor board; electrical conductors internal to the mat for the resistance heating in the mat and for connecting the mat to an onboard power source of at least 12 volts and 20 amps wherein the mat may be placed on a floor of a vehicle and connected to a power source to enable controlled heat to be delivered to the floor board and to reduce icy and wet conditions in the compartment of the vehicle. The mat may be plastic, urethane, neoprene or other composite materials to enclose the conductors internal to the mat and transfer the electrically produced heat to the vehicle's compartment at the floor board area. An alternative embodiment also comprises the above and a means for controlling the power to the conductors from the power source. An alternative embodiment may include a boost transformer/converter to produce higher voltage and enable the heating conductors to be smaller and easier for manufacturing the heating mat. The mat may be plastic, urethane, neoprene or other composite materials to enclose the conductors internal to the mat and transfer the electrically produced heat to the vehicle's compartment at the floor board area.

There is shown in FIGS. 1-7 a complete description and operative embodiment of the Special heating floor mat device and systems for heavy duty and commercial vehicle applications. In the drawings and illustrations, one notes well that the FIGS. 1-7 demonstrate the general configuration and use of this product. The various example uses are in the operation and use section, below.

The accompanying drawings, which are incorporated in and constitute a part of this specification, illustrate an embodiment of the Special heating floor mat for heavy duty applications device 30 that is preferred. The drawings together with the summary description given above and a detailed description given below serve to explain the principles of the Special heating floor mat for heavy duty applications device 30. It is understood, however, that the Special heating floor mat device and systems for heavy duty and commercial vehicle applications 30 is not limited to only the precise arrangements and instrumentalities shown. Other examples of heavy duty heating mat devices and uses are still understood by one skilled in the art of electrical heating mat devices to be within the scope and spirit shown here.

FIGS. 1 A through 1 C are sketches of the general Special heating floor mat for heavy duty applications device 30. The sketches are a generally top view FIG. 1 A and a section view from both the side, FIG. 1 B and the end, FIG. 1 C.

FIGS. 2 A through 2 C are sketches of the general Special heating floor mat for heavy duty applications device with components and features noted. FIG. 2 A shows the top anti-skid top surface 32. This may be one of a plethora of designs such as the shown “X” ribs, straight ribs, herringbone designs and the like. The side hold down component 40 and the extended one 40A with an optional area for a wire way 41 is shown as well. These are generally a “ZEE” cross section. The components 40, 40A may be comprised of a metal such as steel or aluminum and may be coated with a powder coat, paint, or other surface finish. They 40, 40A may also be made of a heavy duty, durable plastic or composite material. These components 40, 40A feature a hold down clip extension 43 and apertures for receiving hold down fasteners 42 such as bolts or other fasteners. These means to fasten 42 are used to removably secure the components to the floor board 61 of the vehicle 60 (not shown, see FIG. 7). FIG. 2 B shows the clips 43 are extended into the mat 30 through the apertures 34 shown in the mat 30. This side view also shows the conductors 50A internal to the mat and in the recess 35A of the mat support 35. The top surface 32 is sandwiched between the hold down component 43 and the support mat 35. FIG. 2 C shows the end view with the similar components including a section of the conductor 35. The end view also further shows the other aforementioned components and features. The Support mat 35 has a Material means to contain resistance heat line 35A such as closed cell urethane, rubber, neoprene or equal.

FIGS. 3 A through 3 D are sketches of a prototype sample with the components and features shown from generally a top view. The CIP includes a boost feature FIG. 3 D. FIGS. 3 A through 3 C are sketches of a prototype sample 31 with the components and features shown from generally a top view. Here in the prototype samples 31 the top anti skid surface 32, the electrical conductors 50, the top surface apertures 34, and a controller 51 are all shown in an actual product 31. One skilled in automotive and other types of electrical circuitry well appreciates the plethora of control devices currently available in the marketplace. This heat mat anticipates as an example and not as a limitation an on-off switch, a rheostat and/or a fuse device. The fuse device may be replaceable or resettable. FIG. 3 D shows the addition of the Voltage Boost Transformer/Converter—converts 12 and 24 V to higher voltages such as 18, 24, 36, and 48 volts 65. These are fully regulated switching power converters 65 (switch mode), designed to allow the use of 24 volt equipment in 12 volt, 14 volt, and 16 volt, 24 volt, 36 volt and 48 volt vehicles, marine, military, PLC, and cell tower applications. These are attractive, reliable, robust DC/DC converters good for fork lifts, off-road, construction and recreational equipment. They are relatively immune to vibration and shock, and come in three versions, heavy duty, water proof and military grade. To determine the amperage you need just add up the watts of all the equipment and divide by 13.6 volts. These converters 65 have common negative, so they are not fully isolated, but can be used for almost all 12 volt applications.

FIGS. 4 A and 4 B are sketches of a prototype sample 31 with the components and features shown from generally a side section. Here the support mat 35, the prototype top surface 32A, the surface apertures 34 and the conductors 50 are all shown for an actual sample product 31.

FIGS. 5 A through 5 C are sketches of a prototype sample 31 with the components and features including the hold down component 40 shown from generally a top view. Here the hold down component 40 features are shown as the open aperture 40B or area for the support mat 35 and surface 32A. Also the extended clip 43 is shown for removably securing the mat 32 and 35 to the component 40. The component 40 has features such as the apertures for the fasteners 40A.

FIGS. 6A and 6B, FIG. 7 and FIG. 8 are sketches of uses and are described below.

The details mentioned here are exemplary and not limiting. Other specific components and manners specific to describing a Special heating floor mat for heavy duty applications device 30 may be added as a person having ordinary skill in the field of electrical heating and deicing mat devices and their uses well appreciates.

### OPERATION OF THE PREFERRED EMBODIMENT

The Special heating floor mat device and systems for heavy duty and commercial vehicle applications 30 has been described in the above embodiment. The manner of how the device operates is described below. One notes well that the description above and the operation described here must be taken together to fully illustrate the concept of the Special heating floor mat device and systems for heavy duty and commercial vehicle applications 30. The preferred embodiment of the Special heating floor mat device and systems for heavy duty and commercial vehicle applications is comprised of a special electric heatable floor mat with a non-slip surface; at least one hold down component with features to enable the mat to be removably secured to a floor board; electrical conductors internal to the mat for the resistance heating in the mat and for connecting the mat to an onboard power source of at least 12 volts and 20 amps wherein the mat may be placed on a floor of a vehicle and connected to a power source to enable controlled heat to be delivered to the floor board and to reduce icy and wet conditions in the compartment of the vehicle. The mat may be plastic, urethane, neoprene or other composite materials to enclose the conductors internal to the mat and transfer the electrically produced heat to the vehicle's compartment at the floor board area. An alternative embodiment also comprises the above and a means for controlling the power to the conductors from the power source. An alternative embodiment may include a boost transformer/converter to produce higher voltage and enable the heating conductors to be smaller and easier for manufacturing the heating mat.

The Special heating floor mat device and systems for heavy duty and commercial vehicle applications 30 operates somewhat similar to a conventional house mats except it is a heavy duty surface and a 12 Volt or greater direct current (DC) device. This means that electrical power from an onboard power source 52 is used to energize the resistive conductors 50 of the Special heating floor mat for heavy duty applications device 30. This D C source 52 permits the heating mat 30 to be portable and useful in a vehicle 60. The heavy duty feature permits it to be used in de-icing and heating floor boards 61 in rather larger applications for vehicles 60 such as named in the table below.

Many uses are anticipated for the Special heating floor mat device and systems for heavy duty and commercial vehicle applications 30. Some examples, and not limitations, are shown in the following Table.

| ITEM | DESCRIPTION |
|---|---|
| 1 | Delivery trucks such as FedEx, UPS and |
| | the US Postal Service |
| 2 | Snow removal plows and dump trucks |
| 3 | Metropolitan vehicles including public |
| | works, fire and police vehicles |
| 4 | Over the road long distance vehicles |
| 5 | Emergency vehicles - fire, police, EMT, |
| | and Homeland security |
| 6 | Agricultural trucks, tractors and the |
| | like |
| 7 | Construction vehicles |
| 8 | Military and Homeland security vehicles |
| 9 | Railroad yard totes and mule drivers |
| 10 | Airport baggage handling and airplane |
| | deicing |
| 11 | Oil/gas field operation and maintenance |
| 12 | Logging operations |

FIGS. 6A and 6B are sketches of the Special heating floor mat device and systems for heavy duty and commercial vehicle applications 30 in conjunction with the power source 52. In FIG. 6 A, the mat 30 is directly connected by the conductors 50 to the electrical power source 52. The electrical source 52 is anticipated as a 12 Volt power source. However, the scope of the invention also anticipates other safe vehicle systems of 18, 24, 36 and 48 Volt nominal systems and the mats can be made to accommodate these other voltages. Also anticipated are controllers and fusible interlinks to provide easy operation and safe, over power protection to the users. FIG. 6 B shows the addition of the Voltage Boost Transformer/Converter—converts 12 and 24 V to higher voltages such as 18, 24, 36, and 48 volts 65 to the components shown in FIG. 6 A. This converter 65 is described in FIG. 3 D, above.

FIG. 7 is a sketch of the Special heating floor mat device and systems for heavy duty and commercial vehicle applications 30 in conjunction with the vehicle 60 and how the device 30 is used. The device 30 is removably secured to the floor board 61 of the vehicle 60 by the above described fasteners 42 through apertures 40A in the hold down component 40 (fasteners and features not shown). The device 30 is then electrically connected to the power source 52 by means of the conductors 50 and optional fusible controllers 50A. The mat device 30 is generally mounted in front of the seats 63 and on the compartment side of the firewall 62. The power supply 52 is generally (although not limited to only) secured in the engine compartment side of the firewall 52. The conductors 50 join the mat 30 to the power source 52. The conductors may be of copper, aluminum or a heat resistant composite material that gets warm as electrical current running through the conductor.

FIG. 8 is a sketch of typical schematic diagram of the boost transformer/converter 65 used with the Special heating floor mat device and systems for heavy duty and commercial vehicle applications as shown in this CIP. One skilled in electrical circuit diagrams fully understand the sketch. The main scope is adding the boost transformer to the Special heating floor mat device and systems for heavy duty and commercial vehicle applications so that the heating cables and resistance wiring 50A may be of smaller diameter and easier to manufacture—while still getting the same power to the mat 30.

With this description it is to be understood that the Special heating floor mat for heavy duty applications device 30 is not to be limited to only the disclosed embodiment of product. The features of the Special heating floor mat for heavy duty applications device 30 are intended to cover various modifications and equivalent arrangements included within the spirit and scope of the description.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described. All patents and publications mentioned herein, including those cited in the Background of the application, are hereby incorporated by reference to disclose and described the methods and/or materials in connection with which the publications are cited.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Thus the scope of this invention should be determined by the appended claims and their legal equivalents. Therefore, it will be appreciated that the scope of the present invention fully encompasses other embodiments which may become obvious to those skilled in the art and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention for it to be encompassed by the present claims. Furthermore, no element, component, or method step in the present disclosure is intended to be dedicated to the public regardless of whether the element, component, or method step is explicitly recited in the claims.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A heating floor mat device for large, commercial vehicle applications including snow removal plows, dump trucks, public works vehicles, fire vehicles, over the road long distance vehicles, FEDEX®, UPS® and U.S. POSTAL SERVICE® delivery trucks, emergency vehicles, agricultural trucks, agricultural tractors, construction vehicles, military and homeland security vehicles comprised of:
(a) an electrically heatable, universal one-sized floor mat made of durable, resilient and composite material and having a non-slip surface, the surface with a means for traction;
(b) a support mat below and contiguous with the heatable floor mat, the support mat having recesses for an electrical resistance wiring and apertures for a hold down extension clip for securing the support mat to an at least one hold down component;
(c) the at least one hold down component with at least one aperture for a fastening means and the hold down extension clip to enable the heatable mat and the contiguous support mat to be removably secured to a floor board of a vehicle and to prevent slips by an occupant when entering the vehicle;
(d) the electrical resistance wiring placed internal to the support mat for a resistance heating in the support mat;
(e) a set of electrical conductors connecting the resistance wiring to an onboard power source; and
(f) a means for fastening to removably secure the hold down component through the at least one aperture to the floor board of the vehicle
wherein the device is placed on the floor board of the vehicle and connected to the power source to enable heat to be delivered to the floor board and to reduce icy and wet conditions in a compartment of the vehicle in front of at least one seat.

2. The device according to claim 1 wherein the composite material is a plastic material.

3. A heating floor mat device for heavy duty large, commercial vehicle applications including snow removal plows, dump trucks, public works vehicles, fire vehicles, over the road long distance vehicles, FEDEX®, UPS® and U.S. POSTAL SERVICE® delivery trucks, emergency vehicles, agricultural trucks, agricultural tractors, construction vehicles, military and homeland security vehicles comprised of:
(a) an electrically heatable, universal one-sized floor mat made of durable, resilient and composite material and having a non-slip surface, the surface with a means for traction;
(b) a support mat below and contiguous with the heatable floor mat, the support mat having recesses for an electrical resistance wiring and apertures for a hold down extension clip for securing the support mat to an at least one hold down component;
(c) the at least one hold down component with at least one aperture for a fastening means and the hold down extension clip to enable the heatable mat and the contiguous support mat to be removably secured to a floor board of a vehicle and to prevent slips by an occupant when entering the vehicle;
(d) the electrical resistance wiring placed internal to the support mat for a resistance heating in the support mat;
(e) a set of electrical conductors connecting the resistance wiring to an onboard power source;
(f) a heavy duty means, of 12 volt and at least 20 amp for controlling the power to the conductors from the power source; and
(g) a means for fastening to removably secure the hold down component through the at least one aperture to the floor board of the vehicle
wherein the device is placed on the floor board of the vehicle and connected to the power source to enable controlled heat to be delivered to the floor board and to reduce icy and wet conditions in a compartment of the vehicle in front of at least one seat.

4. The device according to claim 3 wherein the means for controlling is a replaceable fused link.

5. The device according to claim 4 wherein the means for controlling is a resettable fused link.

6. The device according to claim 3 further comprised of a boost transformer to change the 12 volts to a higher operating voltage.

7. The device according to claim 6 wherein the heavy duty, 12 volt and at least 20 amp means is from the group consisting of 12, 18, 24, 36 and 48 Volt nominal electrical systems.

8. A heating floor mat device for large, commercial vehicle applications including snow removal plows, dump trucks, public works vehicles, fire vehicles, over the road long distance vehicles, FEDEX®, UPS® and U.S. POSTAL SERVICE@ delivery trucks, emergency vehicles, agricultural trucks, agricultural tractors, construction vehicles, military and homeland security vehicles comprised of:
(a) an electrically heatable, universal one-sized floor mat made of durable, resilient and plastic and having a non-slip herringbone surface for traction;
(b) a support mat below and contiguous with the heatable floor mat, the support mat having recesses for an electrical resistance copper wiring and apertures for a hold down extension clip for securing the support mat to one hold down component;
(c) the at least one hold down component with at least one aperture for a fastening means and the hold down extension clip to enable the heatable mat and the contiguous support mat to be removably secured to a floor board of a vehicle and to prevent slips by an occupant when entering the vehicle;
(d) the electrical resistance copper wiring placed internal to the support mat for a resistance heating in the support mat;
(e) a set of electrical conductors connecting the resistance wiring to an onboard power source of at least 12 volts and 20 amps;
(f) a boost transformer to change the 12 volts to a higher operating voltage; and
(g) a means for fastening to removably secure the hold down component through the at least one apertures to the floor board of the vehicle
wherein the device is placed on the floor board of the vehicle and connected to the power source to enable heat to be delivered to the floor board and to reduce icy and wet conditions in a compartment of the vehicle in front of at least one seat.
